(19) United States
(12) Patent Application Publication
(10) Pub. No.: US 2011/0082398 A1
(43) Pub. Date: Apr. 7, 2011

(54) Gate master

(76) Inventor: Jonh Michael McDuffie, Marco Island, FL (US)

(21) Appl. No.: 12/587,065

(22) Filed: Oct. 1, 2009

(51) Int. Cl. A61H 1/00

(52) U.S. Cl. 601/35

(57) ABSTRACT

The present invention is for rehabilitation, mainly for stroke, brain or nerve damaged patients. Due to a stroke, brain injury or nerve damage a patient's feet become paralyzed unresponsive and the feet turn inward not allowing a proper gate. The patient must relearn lower legs, feet and gate control. The Gate Master embodiment provides rehabilitative stimulation to the lower legs and feet, while improving gate control.

### SUMMARY OF THE INVENTION

The present invention is for rehabilitation, mainly for stroke, brain, or nerve damaged patients. Due to a stroke, brain injury or nerve damage a patient's feet become paralyzed and unresponsive. The patient must relearn proper gate control, as the patient attempts to walk the feet are drawn inward breaking the gate or stride. When used properly, this invention can greatly improve gate control. The invention is comprised of one unit with several moving and adjustable parts shown as FIGS. 1 and 2.

To achieve this objective the Gate Master invention comprises a base frame for stability, on which the left and right tracks are affixed, two adjustable foot boxes are attached to the track which allows the wheels on the bottom of the foot boxes to glide from front to back while holding the patient's feet turned slightly outward, thus improving the patient's gate, a handle bar rises up between the patient's legs for their stability.

### BRIEF DESCRIPTION OF THE DRAWINGS

FIG. 1 is a top view from the top of the Gate Master according to the present invention.

FIG. 2 is a side view of the present invention.

### DETAILED DESCRIPTION OF THE DRAWINGS

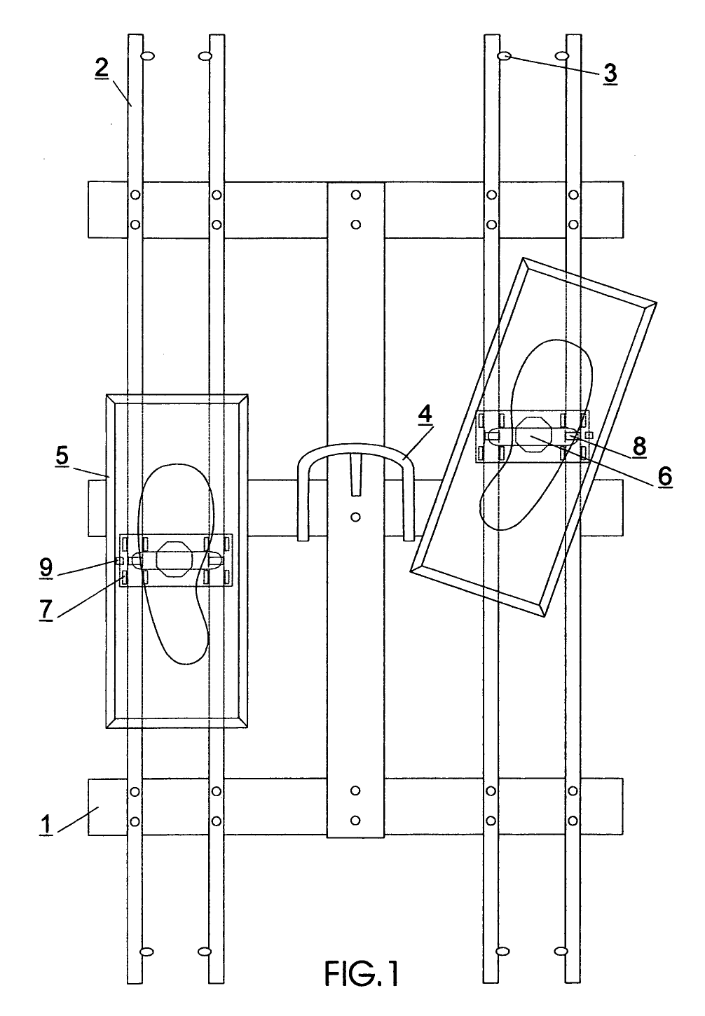

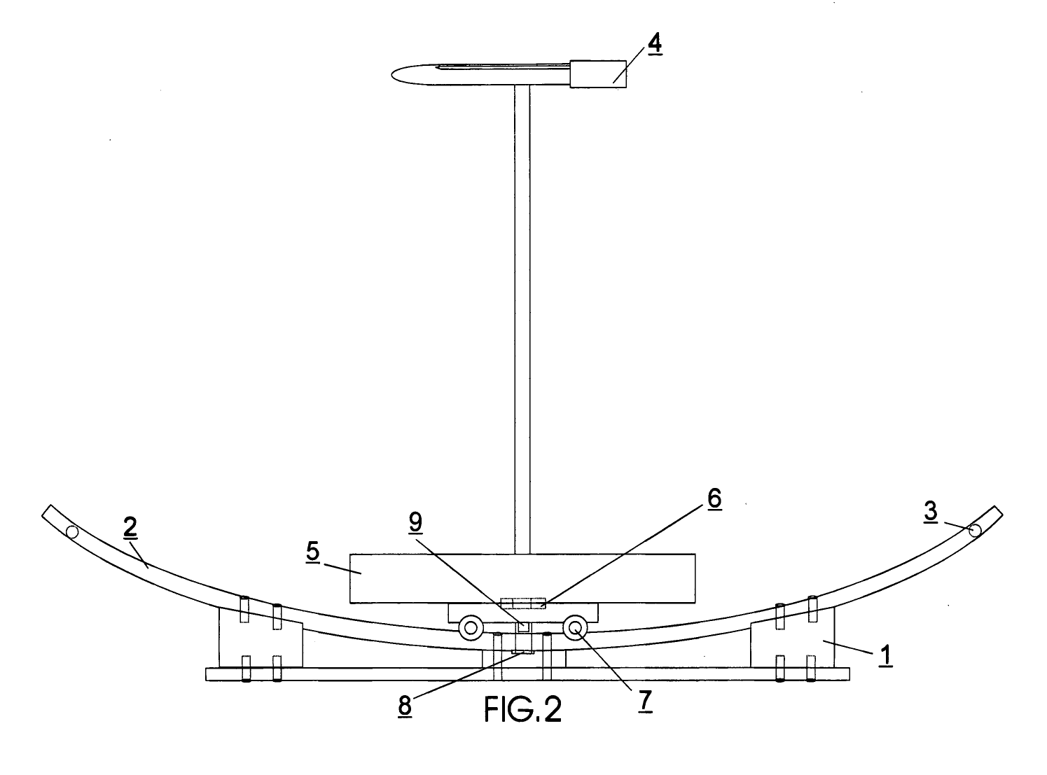

Referring to FIGS. 1 and 2, the Gate Master in accordance with the present invention is shown comprising a base frame for stability 1, two tracks on which the lower foot boxes glide on 2, track stops at each end 3, handle bars for support 4, upper foot boxes with male adjustment 5, lower foot boxes with female adjustment 6, wheels on the lower foot boxes that glide on tracks 7, anti track jump 8, drag or speed adjustment against track 9.

Particular embodiments of the invention have been described in detail for the purposes of illustration; however, various modifications and enhancements may be made without departing from the spirit and scope of the invention. Also, the invention is not to be limited except as by the appended claims. The present invention can be used with electrical stimulation devices to help turn the patient's feet outward.

The invention claim is:

1. The Gate Master is for rehabilitation, mainly for victims of stroke, brain injury or nerve damage. The patient must relearn lower legs, feet and gate control. The rehabilitation embodiment provides manipulative stimulation to the lower legs and feet to help improve gate control.
FIGS. 1 and 2, A base frame for stability, two feet boxes on which the patient places their feet; the feet boxes glide in opposite directions as the patient holds on to the handlebars for support. The patient's feet try to turn inward, due to stroke, brain or nerve damage; however, foot boxes are adjusted slightly outward so the patient can strive for proper gate control. When used as directed this invention will greatly enhance proper gate control.
